(19) United States
(12) Patent Application Publication
(10) Pub. No.: US 2025/0344728 A1
(43) Pub. Date: Nov. 13, 2025

(54) Integrated Liquid and Egg System

(71) Applicant: Jinjin Yang, XXBloomington, IL (US)

(72) Inventor: Jinjin Yang, XXBloomington, IL (US)

(21) Appl. No.: 18/747,612

(22) Filed: Jun. 19, 2024

Related U.S. Application Data
(60) Provisional application No. 63/643,450, filed on May 7, 2024.

(51) Int. Cl. A23L 15/00; A23F 5/24; A23F 5/46; A47J 36/02; A47J 36/04

(52) U.S. Cl. CPC A23L 15/30; A23F 5/243; A23F 5/46; A47J 36/027; A47J 36/04

(57) ABSTRACT

An integrated liquid and egg system is disclosed. The system includes a bottom microwave-safe enclosure for pre-made coffee and a top enclosure for a hardboiled egg. A protective lid is securely attached to the bottom enclosure. The enclosures are sealed using a seal and can be removed to consume the coffee and the egg. In one embodiment, a temperature indicator and a built-in heating element are included for maintaining optimal coffee temperature. In use, the enclosures are separated, the coffee is heated, and the egg is placed into the coffee (i.e., steeped) to achieve the desired temperatures for both the coffee and the egg. The system offers convenience, portability, and a healthy breakfast option for consumers on the go.

### CROSS-REFERENCE TO RELATED APPLICATION

The present application claims priority to, and the benefit of, U.S. Provisional Application No. 63/643,450, which was filed on May 7, 2024, and is incorporated herein by reference in its entirety.

### FIELD OF THE INVENTION

The present invention generally relates to the field of packaged food items. More specifically, the present invention relates to a novel breakfast food item. The breakfast food item device includes a sealed package of coffee and a sealed package of hardboiled egg. The packages are microwave-safe packages and are sealed together. The egg can be removed independently, and coffee can be kept in a microwave to warm. The cold hardboiled egg can be placed into the heated coffee to warm and infuse with coffee flavor. The device offers a healthy, simple, delicious, and quick breakfast for coffee lovers. Accordingly, the present disclosure makes specific reference thereto. Nonetheless, it is to be appreciated that aspects of the present invention are also equally applicable to other like applications, devices, and methods of manufacture.

### BACKGROUND

By way of background, breakfast is the most important meal of the day and is essential for providing the necessary energy and nutrients. However, many individuals, particularly those with demanding schedules, struggle to consume a healthy breakfast regularly. Such individuals often have the pressure to reach the office or attend early meetings which often leads to missing breakfast and thus negatively impacting their ability to maintain a balanced and healthy lifestyle. Fruits, breads, and other breakfast products do not provide necessary macros.

As a result, individuals often rely on ready-made breakfast products. Such products are often high in calories, sugar, and carbohydrates and fail to offer the nutritional balance required for sustained energy and optimal health. Such products may contribute to spikes in blood sugar levels, followed by rapid declines, leading to mid-morning energy slumps and reduced productivity.

Additionally, preparing a nutritious breakfast can be time-consuming, which is impractical for those with tight schedules. Traditional breakfast preparation involves cooking, which many busy professionals cannot afford in their limited morning time. Individuals desire macronutrients in their breakfast but existing breakfast options are carbohydrate-heavy and do not provide protein and healthy fats. Busy individuals desire a ready-to-eat and nutritionally balanced breakfast option.

Therefore, there exists a long-felt need in the art for an improved breakfast food item. There is also a long-felt need in the art for an improved food item that offers ready-to-eat, nutritionally balanced breakfast option catering to the needs of busy individuals. Additionally, there is a long-felt need in the art for a breakfast item that combines a hardboiled egg and black coffee. Moreover, there is a long-felt need in the art for an enhanced breakfast item that features two individual microwave-safe packages storing a hardboiled egg and black coffee individually. Further, there is a long-felt need in the art for a breakfast item that provides adequate macronutrients and can be consumed on the go. Furthermore, there is a long-felt need in the art for a pre-packaged cup of black coffee and a hardboiled egg designed for convenience, health, and efficiency. Finally, there is a long-felt need in the art for a breakfast item that provides protein and healthy fats for supporting a healthy lifestyle without sacrificing convenience.

The subject matter disclosed and claimed herein, in one embodiment thereof, comprises a integrated and ready-to-eat liquid (i.e., coffee or tea) and egg system. The system features a bottom microwave-safe container having a base and a cylindrical wall extending vertically from the base for storing pre-made coffee. A protective lid is removably attached to the top periphery of the bottom microwave-safe enclosure to prevent the coffee from spilling. A top enclosure is integrated with the protective lid and sealed using an adhesive. The top enclosure is adapted to store a hardboiled egg resting on the top surface of the protective lid. The top enclosure protects the hardboiled egg from humidity, oxidation, and unsanitary conditions.

In this manner, the integrated liquid (i.e., coffee or tea) and egg system of the present invention accomplishes all of the foregoing objectives and provides users with a novel ready-to-eat, nutritionally balanced breakfast which includes a hardboiled egg and black coffee. The breakfast is a rich source of protein and healthy fats and does not require any cooking. The system includes two microwave-safe packages that house the black coffee and the hardboiled egg such that users can easily remove the egg to heat the coffee in the microwave. Users can place the cold hardboiled egg in the heated coffee to warm the egg and infuse the egg with coffee flavor. The system eliminates use of junk breakfast items and requirement of cooking breakfast.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an integrated liquid and egg system. The system further comprises a bottom microwave-safe enclosure configured as a container with a base and a cylindrical wall extending vertically from the base, forming an interior cavity to accommodate a pre-made coffee. A protective lid is removably attached to the top periphery of the bottom microwave-safe enclosure to prevent the coffee from spilling. A top enclosure is integrated with the protective lid and sealed using an adhesive, adapted to store a hardboiled egg resting on the top surface of the protective lid. The top enclosure protects the hardboiled egg from humidity, oxidation, and unsanitary conditions.

In yet another embodiment, an integrated liquid (i.e., coffee or tea) and egg system is disclosed. The system features a bottom microwave-safe enclosure configured as a container with a base and a cylindrical wall extending vertically from the base, a protective lid removably attached to the top periphery of the bottom microwave-safe, a top enclosure, convex-shaped and transparent or translucent, is integrated with the protective lid and sealed using an adhesive, adapted to store a hardboiled egg, a temperature indicator is disposed on the outer surface of the bottom microwave-safe enclosure to indicate the temperature of the coffee stored therein, and a built-in heating element is disposed in the base of the bottom microwave-safe enclosure for heating the coffee, operable by a control button.

In another embodiment, the top enclosure is infused with a flavor, including, but not limited to, coffee and herbs, for infusing a flavor into the stored egg.

In another aspect, the inner surface of the bottom microwave-safe enclosure has a flavored coating for introducing a flavor to the stored coffee.

In yet another aspect, the protective lid is adapted to be used independently for covering the bottom microwave-safe enclosure.

In yet another embodiment, a method of preparing a integrated liquid (i.e., coffee or tea) and egg breakfast is disclosed. The method includes the steps of providing a combined liquid (i.e., coffee or tea) and egg breakfast sealed packaging, removing a top enclosure containing a hardboiled egg from a bottom microwave-safe enclosure containing pre-made coffee, placing the bottom microwave-safe enclosure containing the coffee in a microwave and heating the coffee to a desired temperature, removing the heated bottom microwave-safe enclosure from the microwave, inserting the hardboiled egg from the top enclosure into the heated coffee to simultaneously cool the coffee to a drinkable temperature and warm the egg to an optimal eating temperature, and removing the warmed egg from the coffee for consumption.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of combined liquid and egg packaged food device of the present invention in a packaged or sealed state in accordance with the disclosed structure;

FIG. 2 illustrates a perspective view showing the top enclosure being removed from the bottom enclosure for removing the hardboiled egg in accordance with one embodiment of the present invention;

FIG. 3 illustrates a perspective view showing the coffee container of the breakfast system placed in a microwave for heating coffee in accordance with the disclosed structure; and

FIG. 4 illustrates a perspective view showing the hardboiled egg being soaked, for example, in the hot coffee in accordance with one embodiment of the present invention;

FIG. 5 illustrates a perspective view of a packaged, pre-soaked coffee egg in accordance with one embodiment of the present invention; and

FIG. 6 illustrates a perspective view of another embodiment of the integrated liquid (i.e., coffee or tea) and egg system of the present invention in a sealed state in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved breakfast food item. There is also a long-felt need in the art for an improved food item that offers ready-to-eat, nutritionally balanced breakfast option catering to the needs of busy individuals. Additionally, there is a long-felt need in the art for a breakfast item that combines a hardboiled egg and black coffee. Moreover, there is a long-felt need in the art for an enhanced breakfast item that features two individual microwave-safe packages storing a hardboiled egg and black coffee individually. Further, there is a long-felt need in the art for a breakfast item that provides adequate macronutrients and can be consumed on the go. Furthermore, there is a long-felt need in the art for a pre-packaged cup of black coffee and a hardboiled egg designed for convenience, health, and efficiency. Finally, there is a long-felt need in the art for a breakfast item that provides protein and healthy fats for supporting a healthy lifestyle without sacrificing convenience.

The present invention, in one exemplary embodiment, is an integrated liquid (i.e., coffee) and egg system. The system features a bottom microwave-safe container with a base and a cylindrical wall extending vertically from the base, a protective lid removably attached to the top periphery of the bottom microwave-safe. A top enclosure is integrated with the protective lid and is sealed using an adhesive. The top enclosure is adapted to store a hardboiled egg. A temperature indicator is disposed on the outer surface of the bottom microwave-safe enclosure to indicate the temperature of the coffee stored therein, and a built-in heating element is disposed in the base of the bottom microwave-safe enclosure for heating the coffee, operable by a control button. The container can also be put in a microwave for heating the coffee and the egg can be placed into the coffee for heating the egg and infusing with coffee flavor.

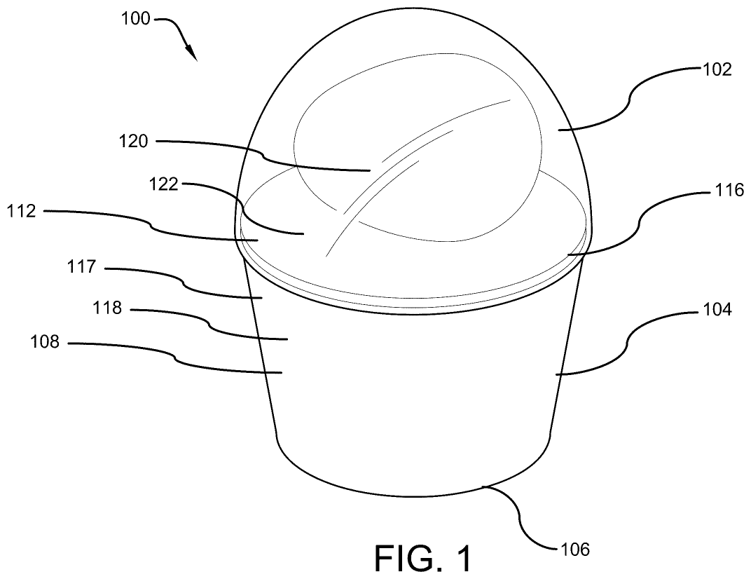

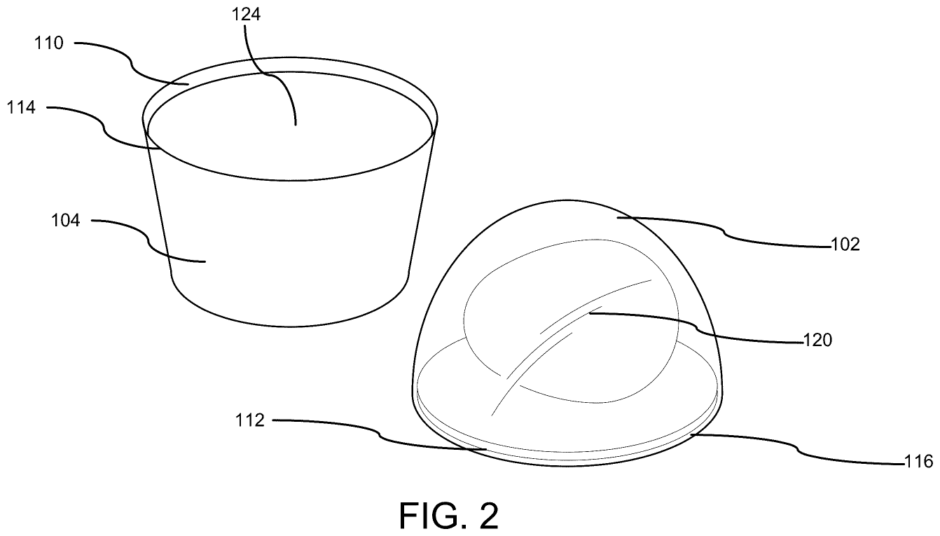

Referring initially to the drawings, FIG. 1 illustrates a perspective view of combined liquid (i.e., coffee) and egg packaged food device of the present invention in a packaged or sealed state in accordance with the disclosed structure. The integrated liquid (i.e., coffee) and egg system 100 is designed as a unique ready-to-eat food product consisting of black coffee and a hardboiled egg. More specifically, the food package 100 includes a top enclosure 102 and a bottom microwave-safe enclosure 104. The bottom microwave-safe enclosure 104 is in the form of a container and has a base 106 and a cylindrical wall 108 extending vertically from the base 106. The cylindrical wall 108 forms an interior cavity 110 (FIG. 2) for accommodating a pre-made coffee. The bottom microwave-safe enclosure 104 can have any geometric shape and can store up to 24 oz. of coffee. A protective lid 112 is adapted to removably attached to the top periphery 114 of the bottom microwave-safe enclosure 104. The protective lid 112 prevents the coffee from spilling when the food package 100 is transported or stored.

The top enclosure 102 is a convex-shaped enclosure and is preferably transparent or translucent. The enclosure 102 is integrated to the periphery 116 of the protective lid 112 and is sealed using an adhesive 117 with the outer surface 118 of the bottom microwave-safe enclosure 104. The top enclosure 102 is adapted to store one hardboiled egg 120 such that the egg 120 rests on the top surface 122 of the lid 112. The top enclosure 102 protects the hardboiled egg 120 from humidity, oxidation, and unsanitary conditions. The top enclosure 102 and the bottom enclosure 104 can be made of biodegradable plastic which can withstand microwave heating without releasing harmful chemicals. Alternatively, the enclosures 102, 104 can be made of food-grade silicone and microwave-safe paper products.

The packaged food device 100 can come in different sizes and is easy to carry, transport, and store. Further, the package food device 100 can be kept in a refrigerator for extending shelf life and can also be kept inside a microwave for heating coffee.

FIG. 2 illustrates a perspective view showing the top enclosure being removed from the bottom enclosure for removing the hardboiled egg in accordance with one embodiment of the present invention. The adhesive seal 117 is broken or removed from the outer surface 118 of the container 104 and the top enclosure 102 is detached from the bottom microwave-safe enclosure 104. In the present embodiment, when the top enclosure 102 is removed, the protective lid 112 is also removed but keeps integrated to the top enclosure 102 enabling the egg 120 to remain sealed.

The container 104 can be kept in a microwave for heating the black coffee 124 and the container 104 can be directly used for drinking. The inner surface 126 of the container 104 can have a flavored coating 128 for introducing a flavor to the stored coffee 124. The container 104 provides insulation and the protective lid 112 can be used independently for covering the container 104. The packaged food device 100 enables a user to independently and selectively consume one of the coffee 124 and the egg 120 as per the preferences and is advantageous for commuting and travel.

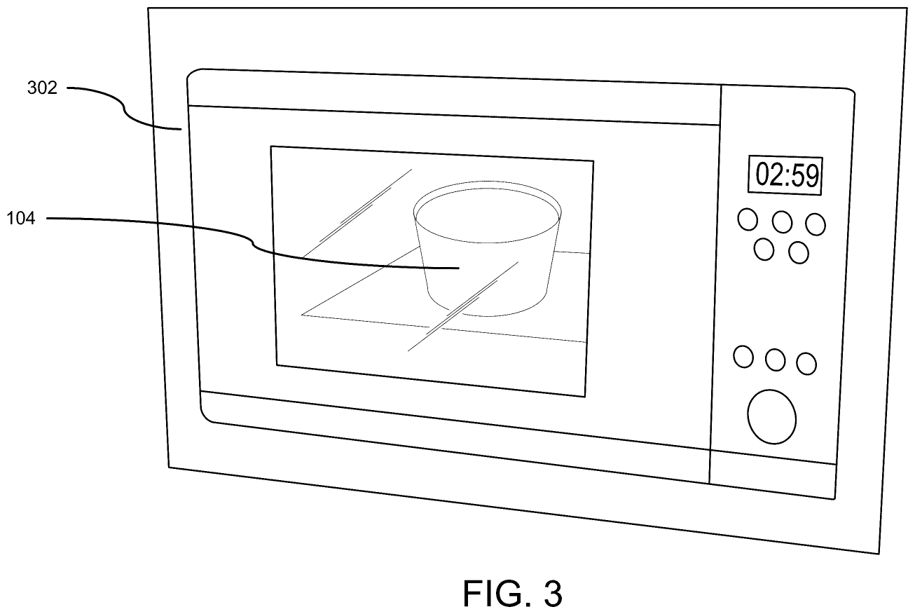

FIG. 3 illustrates a perspective view showing the coffee container of the breakfast system placed in a microwave for heating coffee in accordance with the disclosed structure. The coffee container 104 can be used independently and with the lid 112 removed can be kept in a microwave 302 for heating the coffee 124 for consumption. The coffee 124 can be any coffee flavor or type such as decaf, espresso, and more. The material of the container 104 can maintain the temperature of the coffee 124 for up to 20 minutes.

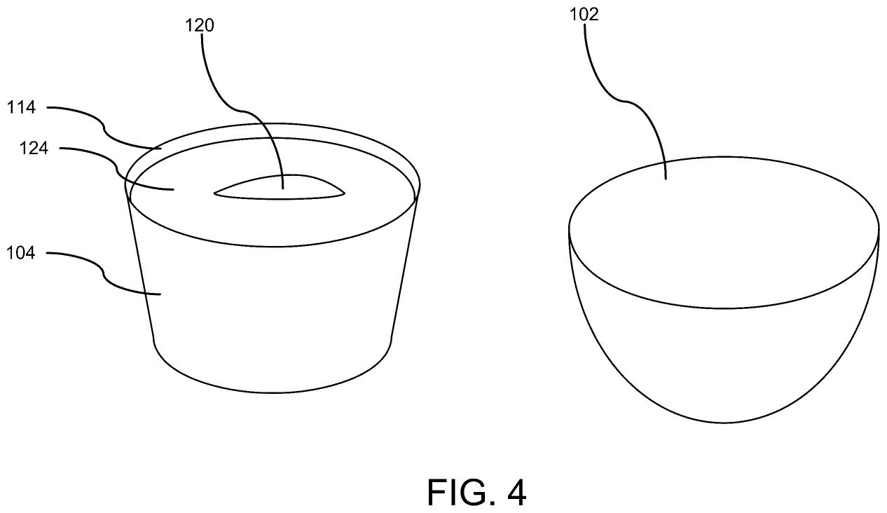

FIG. 4 illustrates a perspective view showing the hardboiled egg being soaked, for example, in the hot coffee in accordance with one embodiment of the present invention. The egg 120 can be easily removed from the enclosure or packaging 102 thereof and can be inserted into (i.e., steeped in) the hot coffee 124. This enables the egg 120 to simultaneously cool the coffee to a drinkable temperature while warming itself to an optimal eating temperature. Then, the egg 120 can be removed from the coffee 124 for consumption separately from the coffee 124.

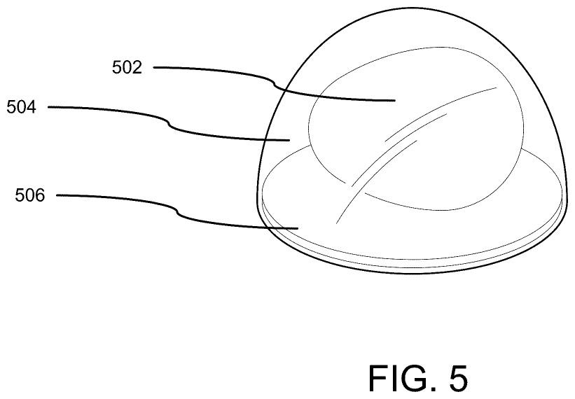

FIG. 5 illustrates a perspective view of a packaged, pre-soaked coffee egg in accordance with one embodiment of the present invention. In the present embodiment, the egg 502 is pre-soaked in coffee solution and is enclosed in a microwave-safe package or enclosure 504. The base 506 of the packaging 504 is made of silicone or paper for maintaining taste and shelf life of the egg 502.

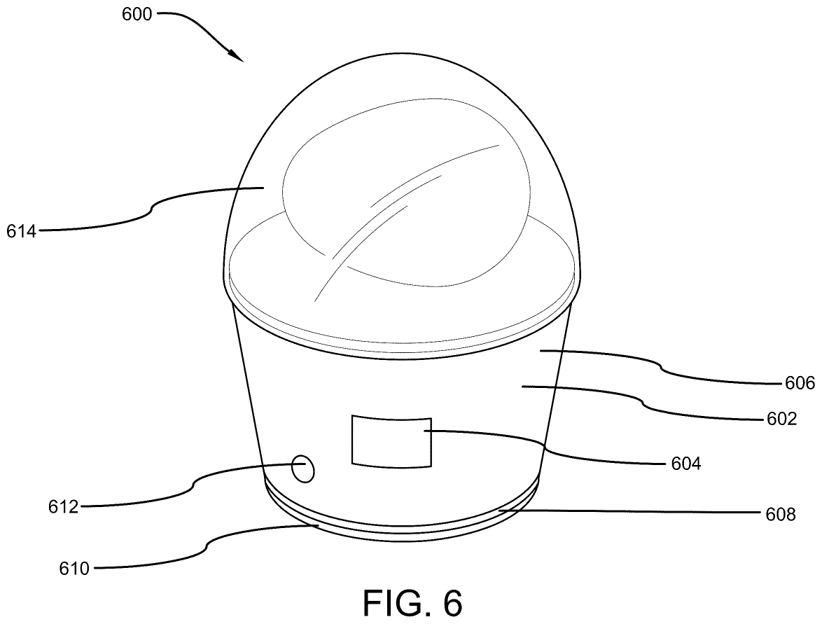

FIG. 6 illustrates a perspective view of another embodiment 600 of the integrated liquid (i.e., coffee) and egg system of the present invention in a sealed state in accordance with the disclosed structure. In the present embodiment, the coffee container 602 includes a temperature indicator 604 indicating temperature of the coffee stored therein. The temperature indicator 604 is disposed on the outer surface 606 of the container 602 for easy accessibility. A built-in heating element 608 is disposed in the base 610 for heating the coffee and can be operated by a control button 612. The egg packaging or enclosure 614 is infused with a flavor including, but not limited to, coffee, herbs, and more for infusing a flavor in the stored egg.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “combined liquid (i.e., coffee) and egg packaged food device”, “integrated liquid (i.e., coffee) and egg system”, “packaged food device”, and “breakfast system” are interchangeable and refer to the integrated liquid (i.e., coffee) and egg system 100, 600 of the present invention.

Notwithstanding the foregoing, the integrated liquid (i.e., coffee) and egg system 100, 600 of the present invention can be of any suitable size and configuration as is known in the art without affecting the overall concept of the invention, provided that it accomplishes the above-stated objectives. One of ordinary skill in the art will appreciate that the integrated liquid (i.e., coffee) and egg system 100, 600 as shown in the FIGS. are for illustrative purposes only, and that many other sizes and shapes of the integrated liquid (i.e., coffee) and egg system 100, 600 are well within the scope of the present disclosure. Although the dimensions of the integrated liquid (i.e., coffee) and egg system 100, 600 are important design parameters for user convenience, the integrated liquid (i.e., coffee or tea) and egg system 100, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An integrated liquid and egg system comprising:
a food package;
a top enclosure;
a bottom microwave-safe enclosure; and
a protective lid;
wherein said bottom microwave-safe enclosure having a base, a cylindrical wall extending vertically from said base, and a top periphery;
wherein said base and said cylindrical wall forming an interior cavity for housing a liquid;
wherein said protective lid removably attached to said top periphery;
wherein said top enclosure integrated to said top periphery and said protective lid;
wherein said top enclosure storing a hardboiled egg; and
further wherein said hardboiled egg resting on a top surface of said protective lid.

2. The integrated liquid and egg system of claim 1, wherein said top enclosure and said bottom microwave-safe enclosure comprising biodegradable plastic.

3. The integrated liquid and egg system of claim 1, wherein said top enclosure and said bottom microwave-safe enclosure comprising food-grade silicone.

4. The integrated liquid and egg system of claim 3, wherein said top enclosure adhesively sealed to said bottom microwave-safe enclosure.

5. The integrated liquid and egg system of claim 4, wherein said top enclosure integrated to said protective lid.

6. The integrated liquid and egg system of claim 5, wherein said top enclosure sealed to an outer surface of said bottom microwave-safe enclosure.

7. The integrated liquid and egg system of claim 6, wherein said lower microwave-safe enclosure having an inner surface including a flavored coating.

8. The integrated liquid and egg system of claim 7, wherein said top enclosure having a material selected from the group consisting of a transparent material and a translucent material.

9. The integrated liquid and egg system of claim 1, wherein said liquid is selected from the group consisting of a coffee and a tea.

10. An integrated coffee and egg food package comprising:
a top enclosure;
a bottom microwave-safe enclosure; and
a protective lid;
wherein said bottom microwave-safe enclosure having a base, a cylindrical wall extending vertically from said base, and a top periphery;
wherein said base and said cylindrical wall forming an interior cavity for housing a coffee;
wherein said protective lid removably attached to said top periphery;
wherein said top enclosure integrated to said top periphery and said protective lid;
wherein said top enclosure storing a hardboiled egg; and
further wherein said hardboiled egg resting on a top surface of said protective lid.

11. The integrated coffee and egg system of claim 10, wherein said top enclosure adhesively sealed to said bottom microwave-safe enclosure.

12. The integrated coffee and egg system of claim 11, wherein said top enclosure integrated to said protective lid.

13. The integrated coffee and egg system of claim 12, wherein said top enclosure sealed to an outer surface of said bottom microwave-safe enclosure.

14. The integrated coffee and egg system of claim 13, wherein said lower microwave-safe enclosure having an inner surface including a flavored coating.

15. The integrated coffee and egg system of claim 10, wherein said top enclosure having a material selected from the group consisting of a transparent material and a translucent material.

16. The integrated coffee and egg system of claim 10, wherein said liquid is selected from the group consisting of a coffee and a tea.

17. A method of integrating a liquid and an egg for a portable meal, the method comprising the steps of:
providing a food package, a top enclosure, a bottom microwave-safe enclosure, and a protective lid, wherein said bottom microwave-safe enclosure having a base, a cylindrical wall extending vertically from said base, and a top periphery, wherein said protective lid removably attached to said top periphery;
forming an interior cavity within said base and said cylindrical wall;
housing a liquid in said interior cavity;
storing a hardboiled egg in said top enclosure;
separating said bottom microwave-safe enclosure from said top enclosure;
removing said hardboiled egg from said top enclosure;
heating said liquid; and
steeping said hardboiled egg in said liquid.

18. The method of integrating a liquid and an egg for a portable meal of claim 17, wherein said top enclosure and said bottom microwave-safe enclosure comprising food-grade silicone.

19. The method of integrating a liquid and an egg for a portable meal of claim 17, wherein said top enclosure selectively sealed to said bottom microwave-safe enclosure.

20. The method of integrating a liquid and an egg for a portable meal of claim 17, wherein said liquid is selected from the group consisting of a coffee and a tea.
